(19) United States
(12) Patent Application Publication
(10) Pub. No.: US 2009/0180064 A1
(43) Pub. Date: Jul. 16, 2009

(54) RESIN COMPOSITION FOR LIGHT BLOCKING MEMBER AND DISPLAY PANEL COMPRISING THE SAME

(76) Inventors: Jin-Seuk KIM, Daedeok-gu (KR); Gwan-Soo KIM, Seoul (KR); Sang-Hun LEE, Suwon-si (KR); Yui-Ku LEE, Gwangmyeong-si (KR)

Correspondence Address: Haynes and Boone, LLP;IP Section, 2323 Victory Avenue, SUITE 700, Dallas, TX, 75219, US

(21) Appl. No.: 12/197,916

(22) Filed: Aug. 25, 2008

(30) Foreign Application Priority Data
Jan. 10, 2008 (KR) 10-2008-0003132

(51) Int. Cl. G02F 1/1335; C08K 5/3415; C08K 5/3462; C08K 5/3417

(52) U.S. Cl. 349/110; 524/92; 524/94; 524/88

(57) ABSTRACT

The present invention relates to a display panel. The display panel includes a substrate, first and second signal lines, a thin film transistor, a plurality of color filters, a light blocking member, an insulating layer, and a pixel electrode. The first and second signal lines are formed on the substrate and cross each other. The thin film transistor is connected to the first and second signal lines. The plurality of color filters is formed on the thin film transistor. The light blocking member is disposed between adjacent color filters and includes a pigment containing R254, Y139, and B15:6. The insulating layer is formed on or below the color filter and the light blocking member. The pixel electrode is formed on the color filter.

### CROSS-REFERENCE TO RELATED APPLICATION

This application claims priority to and the benefit of Korean Patent Application No. 10-2008-0003132 filed in the Korean Intellectual Property Office on Jan. 10, 2008, the entire contents of which are incorporated herein by reference.

### BACKGROUND OF THE INVENTION

(a) Field of the Invention

The present invention relates to a resin composition for a light blocking member and a display panel comprising the same.

(b) Description of the Related Art

A liquid crystal display is a popular type of flat panel display. The liquid crystal display includes two display panels each having electrodes and a liquid crystal layer between the two substrates. The liquid crystal display is a display device for controlling an amount of light by rearranging liquid crystal molecules of the liquid crystal layer by applying a voltage to the electrodes.

Among liquid crystal displays, widely used liquid crystal displays include field generating electrodes formed in two display panels, respectively. Particularly, a general structure of the widely used liquid crystal displays includes one display panel having a plurality of thin film transistors and pixel electrodes disposed in a matrix form and the other panel having red, green, and blue color filters, a light blocking member, and a common electrode covering the entire surface thereof.

However, such a liquid crystal display has a shortcoming of a misalignment due to the difficulty of accurate alignment between a pixel electrode and a color filter or a pixel electrode and a light blocking member because the pixel electrode, color filters, and light blocking member are formed on different display panels.

In order to overcome the shortcoming, a structure has been introduced to form the color filter, the light blocking member, and the pixel electrode on the same panel.

However, if the color filter, the light blocking member, and the pixel electrode are formed on the same display panel, an afterimage may be incurred because carbon black that is used as primary material of the light blocking member is adsorbed at an adjacent insulating layer. Such an afterimage may be shown as a spot.

Since the carbon black has a higher dielectric constant than a normal insulating layer, parasitic capacitance may increase between a signal line and a pixel electrode with the light blocking member as a center.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a resin composition for a light blocking member and a display panel having the same having advantages of improving a display characteristic and reducing parasitic capacitance by preventing afterimage from being incurred by a light blocking member.

An exemplary embodiment of the present invention provides a resin composition for a light blocking member including a polymerizable compound, a binder, and a pigment containing R254, Y139, and B15:6.

The pigment may comprise R254, Y139, and B15:6 at a ratio of about 1.5 to 2.5:about 0.5 to 1.5:about 2.5 to 3.5.

The pigment may comprise R254, Y139, and B15:6 at a ratio of about 2:1:3.

The resin composition for the light blocking member may have optical density higher than 3 in a visible ray.

The R254, Y139, and B15:6 may be expressed as Chemical Formula 1, Chemical Formula 2, and Chemical Formula 3:

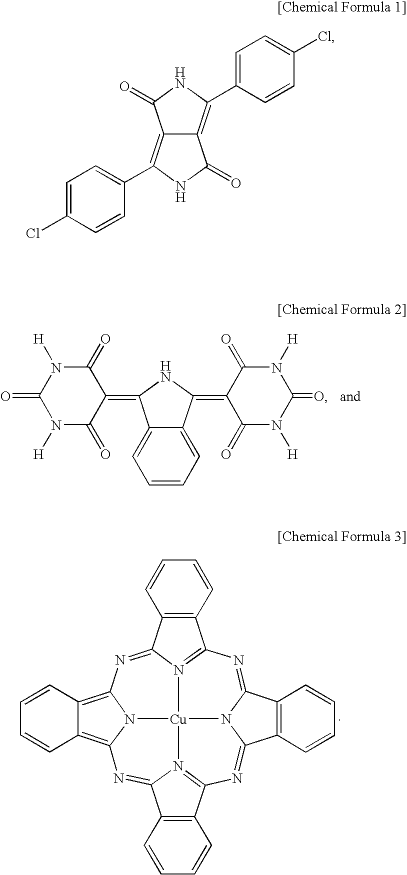

Another exemplary embodiment of the present invention provides a display panel including a substrate, first and second signal lines formed on the substrate and crossing each other, a thin film transistor connected to the first and second signal lines, a plurality of color filters formed on the thin film transistor, a light blocking member disposed between adjacent color filters and including a pigment containing R254, Y139, and B15:6, an insulating layer formed above or below the color filter and the light blocking member, and a pixel electrode formed on the color filter.

The pigment may comprise R254, Y139, and B15:6 at a ratio of about 1.5 to 2.5:about 0.5 to 1.5:about 2.5 to 3.5.

The pigment may comprise R254, Y139, and B15:6 at a ratio of about 2:1:3.

The light blocking member has optical density higher than 3 in a visible ray region.

R254, Y139, and B15:6 may be expressed as Chemical Formula 1, Chemical Formula 2, and Chemical Formula 3.

The pixel electrode may include first and second subpixel electrodes having different voltages.

Each of the first and second subpixel electrodes includes at least two parallelogram electrode plates each having a different inclining direction.

The color filter may have a zigzag shape.

The light blocking member may include a first part formed along an edge of the color filter in a zigzag shape, and a second part formed along at least one of the first and second signal lines.

Another embodiment of the present invention provides a display panel including a substrate, a gate line formed on the substrate, a gate insulating layer formed on the gate line, a data line formed on the gate insulating layer and crossing the gate line, a plurality of color filters formed on the data line, a light blocking member disposed between adjacent color filters, an insulating layer formed above or below the color filter and the light blocking member, and a pixel electrode formed on the color filter. The light blocking member is formed by mixing a red pigment, a yellow pigment, and a blue pigment at a ratio of about 1.5 to 2.5:about 0.5 to 1.5:about 2.5 to 3.5 and has optical density higher than 3 in a visible ray region.

The red pigment, the yellow pigment, and the blue pigment, may be R254, Y139, and B15:6.

The R254, Y139, and B15:6 may be mixed at a ratio of about 2:1:3.

The R254, Y139, and B15:6 may be expressed as Chemical Formula 1, Chemical Formula 2, and Chemical Formula 3.

The pixel electrode may include first and second subpixel electrodes having different voltages.

The color filter may have a zigzag shape. The light blocking member may include a first part formed along an edge of the color filter in a form of a zigzag shape, and a second part formed along the gate line.

As described above, the light blocking member is formed at the thin film transistor array panel in the exemplary embodiment of the present invention. Since the components of the light blocking member are not adsorbed into an adjacent insulating layer in this structure, it is possible to prevent a afterimage from incurring. Also, it is possible to reduce parasitic capacitance between a signal line and a pixel electrode because the light blocking member has a comparative low dielectric constant.

The light blocking member according to the exemplary embodiment of the present invention not only has high optical density but also has uniform optical density at the entire visible ray region. Therefore, it is possible to provide excellent display characteristics and a high contrast ratio.

### BRIEF DESCRIPTION OF THE DRAWINGS

FIG. 1 is a layout view of a liquid crystal display according to an exemplary embodiment of the present invention.

FIG. 2 is a cross-sectional view of a liquid crystal display shown in FIG. 1 taken along the line II-II.

FIG. 3 is an equivalent circuit diagram for one pixel of a liquid crystal display according to another exemplary embodiment of the present invention.

FIG. 4 is a layout view of a liquid crystal display of FIG. 3.

FIG. 5 is a cross-sectional view of a liquid crystal display shown in FIG. 4 taken along the line V-V.

FIG. 6 is a layout view of a pixel electrode and a common electrode in a liquid crystal display shown in FIG. 4 and FIG. 5.

FIG. 7A is a graph showing optical density corresponding to wavelengths when a resin composition for a light blocking member according to an exemplary embodiment of the present invention is used.

FIG. 7B and FIG. 7C are graphs showing optical density corresponding to wavelengths when the resin compositions for a light blocking member according to a comparative embodiment are used.

### DETAILED DESCRIPTION OF THE EMBODIMENTS

The present invention will be described more fully hereinafter with reference to the accompanying drawings, in which exemplary embodiments of the invention are shown. The described embodiments may be modified in various ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

### First Exemplary Embodiment

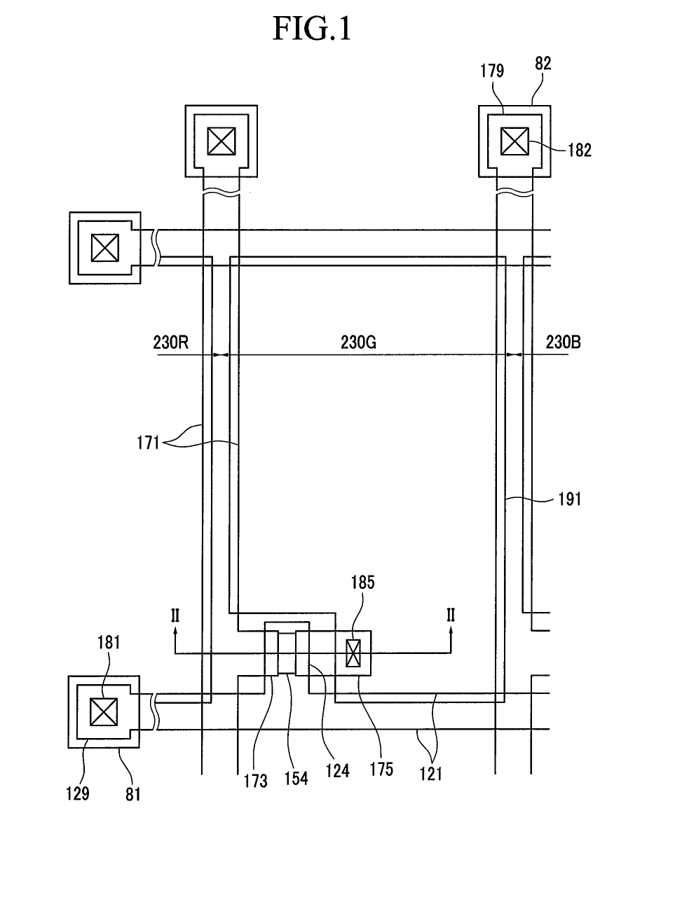

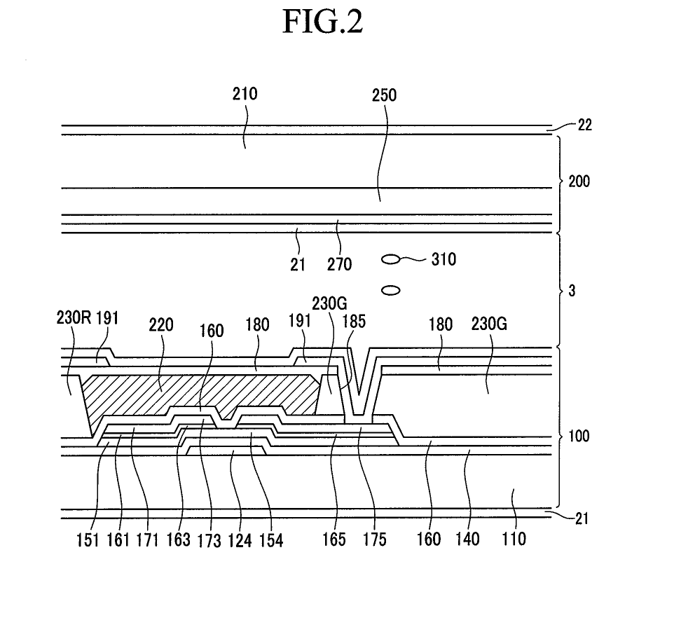

Hereinafter, a liquid crystal display according to an exemplary embodiment of the present invention will be described with reference to FIG. 1 and FIG. 2.

FIG. 1 is a layout view of a liquid crystal display according to an exemplary embodiment of the present invention, and FIG. 2 is a cross-sectional view of a liquid crystal display shown in FIG. 1 taken along the line II-II.

Referring to FIG. 1 and FIG. 2, the liquid crystal display according to an exemplary embodiment of the present invention includes a thin film transistor array panel 100, a common electrode panel 200 facing the thin film transistor array panel 100, and a liquid crystal layer 3 interposed between the thin film transistor array panel 100 and the common electrode panel 200.

Hereinafter, the thin film transistor array panel 100 will be described.

A plurality of gate lines 121 are formed on an insulating substrate 110 to transmit a gate signal. Each of the gate lines 121 includes an end portion 129 for connection to an external circuit and a gate electrode 124 extending upwardly.

A gate insulating layer 140 is formed on the gate lines 121. A semiconductor stripe 151 made of amorphous or crystalline silicon is formed on the gate insulating layer 140. The semiconductor stripe 151 extends in a vertical direction. Each semiconductor stripe 151 includes a protrusion 154 that extends toward the gate electrode 124.

An ohmic contact stripe 161 and a plurality of ohmic contact islands 165 are formed on the semiconductor stripe 151. The ohmic contact stripe 161 may be made of silicide or an n+ hydrogen amorphous silicon with a highly concentrated n-type impurity. The ohmic contact stripe 161 includes a protrusion 163 extending toward the protrusion 154 of the semiconductor stripe 151. The protrusion 163 of the ohmic contact stripe 161 forms a pair with an ohmic contact island 165, which are disposed on the protrusion 154 of the semiconductor stripe 151.

A plurality of data lines 171 and a plurality of drain electrodes 175 are formed on the ohmic contact stripes 161, the ohmic contact islands 165, and the gate insulating layer 140.

The data lines 171 extend in a vertical direction, thereby crossing the gate lines 121. The data lines 171 transmit a data voltage. A plurality of protrusions extending from each of the data lines 171 to the drain electrodes 175 form source electrodes 173, and a pair of the source electrodes 173 face the drain electrode 175 on the gate electrode 124.

The gate electrode 124, the source electrode 173, and the drain electrode 175 form a thin film transistor (TFT) with the protrusion 154 of the semiconductor stripe 151. A channel of the thin film transistor is formed in the protrusion 154 of the semiconductor stripe 151 between the source electrode 173 and the drain electrode 175.

The semiconductor stripe 151 has a plane shape that is substantially identical to that of the data line 171 and the drain electrode 175 except at a channel region between the source electrode 173 and the drain electrode 175.

The ohmic contact stripe 161 is interposed between the semiconductor stripe 151 and the data line 171, and has a plane shape that is substantially identical to that of the data line 171. The ohmic contact island 165 is interposed between the semiconductor stripe 151 and the drain electrode 175, and has a plane shape that is substantially identical to that of the drain electrode 175.

A blocking layer 160 is formed on the data line 171 and the drain electrode 175. The blocking layer 160 may be made of silicon nitride (SiNₓ) or silicon oxide (SiO₂). The blocking layer 160 may prevent an organic material that is a component of a color filter 230 and a light blocking member 220 from adsorbing into the protrusion 154 of the semiconductor stripe 151, which is exposed between the source electrode 173 and the drain electrode 175.

The color filter 230 and the light blocking member 220 are formed on the blocking layer 160.

The color filter 230 may include a red filter 230R, a green filter 230G, and a blue filter 230B. Each color filter extends along a pixel row that is defined by the data line 171 and in parallel with the data line 171. Also, the red filter 230R, the green filter 230G, and the blue filter 230B may be alternately arranged per each of the pixels.

The color filter 230 is not formed at an end portion 129 of the gate line 121 or an end portion 179 of the data line 171, which is coupled to an external circuit.

The light blocking member 220 may be referred to as a black matrix. The light blocking member 220 extends along the gate line 121 and the data line 171 and is disposed between two adjacent color filters 230.

The light blocking member 220 may be made of a resin composition having a polymerizable compound, a binder, and a pigment.

The polymerizable compound is a compound that is polymerizable by light or heat, such as a monomer or an oligomer. The polymerizable compound may include a compound having carbon-carbon unsaturated bonds and/or carbon-carbon ring-type bonds. As examples, the polymerizable compound may be an unsaturated carboxylic acid, an acryl amide based compound, an allyl ester based compound, or a vinyl based compound. The polymerizable compound may be included in the resin composition at about 1 to 20 wt % of the total content of the resin composition. If less than about 1 wt % of the polymerizable compound is included in the resin composition, a pattern may deteriorate and durability may become weaker because developing ability is lowered. If more than about 20 wt % of the polymerizable compound is included in the resin composition, the coating property may deteriorate.

The binder may be an alkali soluble resin, for example an acryl-based or methacryl-based polymer. The binder may be included in the resin composition at about 1 to 20 wt % of the total content of the resin composition. If less than about 1 wt % of the binder is included in the resin composition, the coating property may deteriorate. If more than about 20 wt % of the binder is included in the resin composition, developing ability may deteriorate.

The pigment may be made by mixing a plurality of organic pigments that can be used as pigments for a color filter.

Instead of using inorganic black particles such as carbon black, color pigments made of organic material are mixed and used as the light blocking member as described above. In the present example embodiment, the light blocking member is formed in the thin film transistor array panel. This structure can prevent carbon black having a fine particle size from being adsorbed into an adjacent insulating layer. Therefore, this structure prevents film contamination from being generated.

The dielectric constant of the light blocking member is an important factor in the liquid crystal display having the light blocking member formed in the thin film transistor array panel as in the present embodiment because the light blocking member serves as an insulator by being located between the data line and the pixel electrode. Since the organic pigment has a dielectric constant that is about 3 to 5 times lower than that of the carbon black, it is possible to significantly reduce parasitic capacitance between the data line and the pixel electrode.

Meanwhile, the light blocking member formed by mixing a plurality of color pigments according to the present embodiment must absorb light well in order to perform its original role as the light blocking member. An absorptive ability may be expressed as optical density. Here, the optical density is a scale denoting how much light a light blocking member absorbs when the light passes through the light blocking member. The optical density may be equivalent to absorbance involving the light intensity, thickness, and absorption coefficient. In general, the higher the optical density is, the more light is absorbed in the light blocking member. Conversely, the lower the optical density is, the less light is absorbed in the light blocking member.

In an exemplary embodiment of the present invention, a red pigment, a yellow pigment, and a blue pigment are mixed and used as organic pigments. Here, the red pigment may be R254 expressed as Chemical Formula 1, the yellow pigment may be Y139 expressed as Chemical Formula 2, and the blue pigment may be B15:6 expressed as Chemical Formula 3.

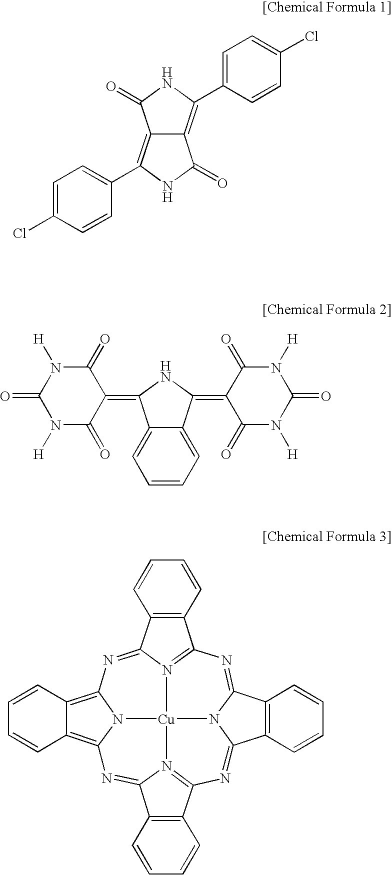

Here, R254, Y139, and B15:6 are color index pigment numbers (C.I. dyes).

A mixing ratio of R254, Y139, and B15:6 can be controlled to be in a predetermined range for absorbing light well. It is preferable to mix R254, Y139, and B15:6 at a ratio of about 1.5 to 2.5:about 0.5 to 1.5:about 2.5 to 3.5. Among them, the ratio of about 2:1:3 is more preferable.

The pigment with the predetermined mixing ratio not only absorbs light well in the visible light region of about 380 to 780 nm range, but also uniformly absorbs light for all wavelengths. If the mixed pigment cannot absorb light well, the mixed pigment cannot operate as the light blocking member. If absorptive ability of the mixed pigment is not uniform for all wavelengths, the display characteristics deteriorate because the mixed pigment passes light of specific wavelengths.

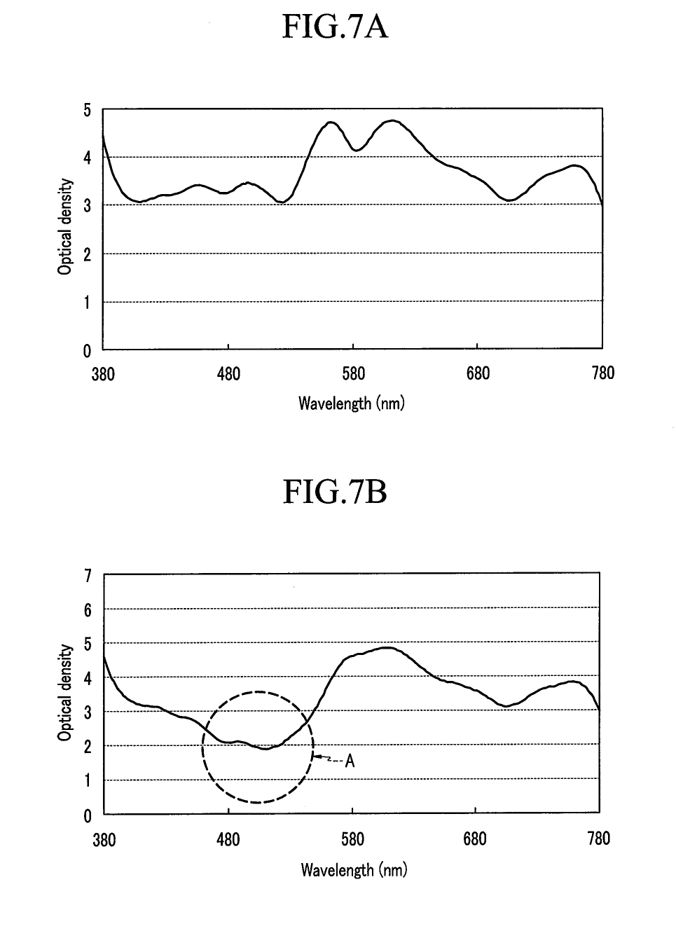

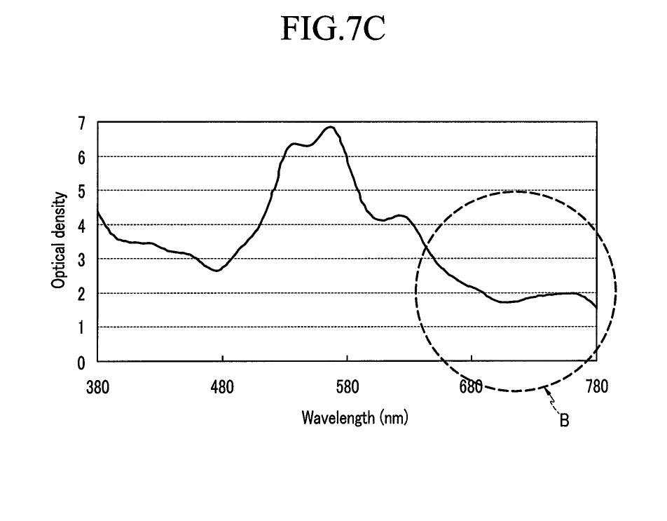

This will be described with reference to FIG. 7A to FIG. 7C.

FIG. 7A is a graph showing optical density corresponding to wavelengths when a resin composition for a light blocking member according to an exemplary embodiment of the present invention is used. FIG. 7B and FIG. 7C are graphs showing optical density according to a wavelength when the resin compositions for a light blocking member according to a comparative embodiment are used.

In detail, FIG. 7A is a graph showing optical density measured if R254, Y139, and B15:6 are mixed and used as a light blocking member according to an exemplary embodiment of the present invention. FIG. 7B is a graph showing optical density measured when a mixed pigment of R177, Y139, and B15:6 is used, and FIG. 7C is a graph showing optical density measured when a mixed pigment of R177, Y139, B15:6, and V23 is used. Here, the total amounts of pigments are identical. Also, types of other components and conditions are the same.

Referring to FIG. 7A, the graph shows that optical density is generally higher than 3 at a wavelength region of about 380 to 780 nm, which is the visible ray region, if the mixed pigment according to an exemplary embodiment of the present invention is used. Also, the graph shows that optical density is generally uniform in all visible ray regions.

On the contrary, referring to FIG. 7B, the graph shows that the optical density abruptly deteriorates at a short wavelength region (A region) of about 450 to 550 nm range if R177 is used as a red pigment instead of R254. If the absorptive ability of light deteriorates at a short wavelength region, light of a short wavelength region, that is, a blue region, is leaked, and is shown as a bluish color at a display panel. Therefore, the image quality deteriorates. Since black cannot be perfectly displayed due to leaked light, the contrast ratio may decrease.

Referring to FIG. 7C, the graph shows that optical density abruptly deteriorates not only at the short wavelength region but also at a long wavelength greater than about 650 nm if violet pigment V23 is further included with the mixed pigment used for FIG. 7B. If the absorptive ability of light at the long wavelength region deteriorates as described above, light is leaked from the long wavelength region, that is, a red region, and it is shown as a reddish color at a display panel. Therefore, the image quality thereof deteriorates. Since the black cannot be perfectly displayed due to leaked light, the contrast ratio also decreases.

Since the mixed pigment according to an exemplary embodiment of the present invention has optical density that is generally higher than 3 in all visual ray regions, the mixed pigment according to the present exemplary embodiment can absorb light well and has uniform absorptive ability for each of the wavelengths, thereby providing excellent display quality and a high contrast ratio.

Such a pigment may be included in the resin composition at about 1 to 15 wt % of the total content of the resin composition for the light blocking member.

The resin composition for the light blocking member may further include a photoinitiator, a surfactant, and a close-adhesion improving agent as well as the polymerizable compound, the binder, and the pigment.

A capping layer 180 is formed on the color filter 230. The capping layer 180 may be made of an inorganic insulating material such as SiNₓ or SiO₂. The capping layer 180 prevents the color filter 230 and the light blocking member 220 from lifting and prevents a chemical solution such as an etching solution from flowing into the color filter 230 and the light blocking member 220 in a following process.

A contact hole 185 is formed in the capping layer 180, the color filter 230, and the blocking layer 160 to expose the drain electrode 175. Also, a contact hole 182 is formed in the capping layer 180 and the blocking layer 160 to expose the end portion 179 of the data line 171. Furthermore, a contact hole 181 is formed in the capping layer 180, the blocking layer 160, and the gate insulating layer 140 to expose the end portion 129 of the gate line 121.

A pixel electrode 191 and a plurality of contact assistants 81 and 82 are formed on the capping layer 180.

The pixel electrode 191 is connected to the drain electrode 175 through the contact hole 185, and receives a data voltage from the drain electrode 175.

The contact assistants 81 and 82 are connected to the end portion 129 of the gate line 121 and the end portion 179 of the data line 171 through the contact holes 181 and 182. The contact assistants 81 and 82 improve the adhesive property between the end portion 129 of the gate line 121 or the end portion 179 of the data line 171 and an external device such as a driver IC, and protect them.

A common electrode 270 is formed on the insulating substrate 210 at the common electrode panel 200 that faces the thin film transistor array panel 100.

Alignment layers 11 and 21 are formed at inner sides of the thin film transistor array panel 100 and the common electrode panel 200, and polarizers 12 and 22 are attached at external sides thereof.

The liquid crystal layer 3 having a plurality of liquid crystal molecules 310 is interposed between the thin film transistor array panel 100 and the common electrode panel 200. The liquid crystal molecules 310 of the liquid crystal layer 3 are rearranged using an electric field generated between the pixel electrodes 191 and the common electrode 270.

### Second Exemplary Embodiment

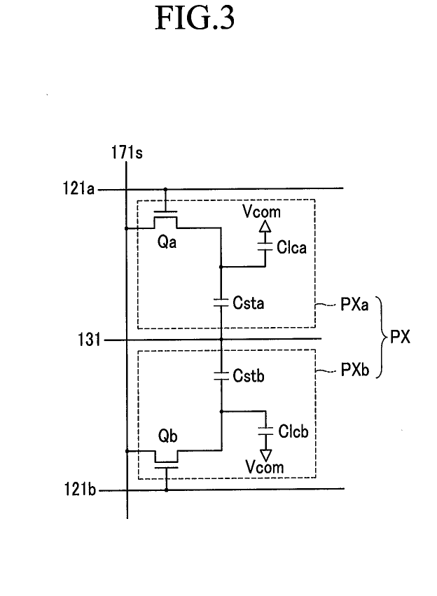

Hereinafter, a liquid crystal display according to another exemplary embodiment of the present invention will be described with reference to FIG. 3 to FIG. 5. Descriptions of like elements are omitted.

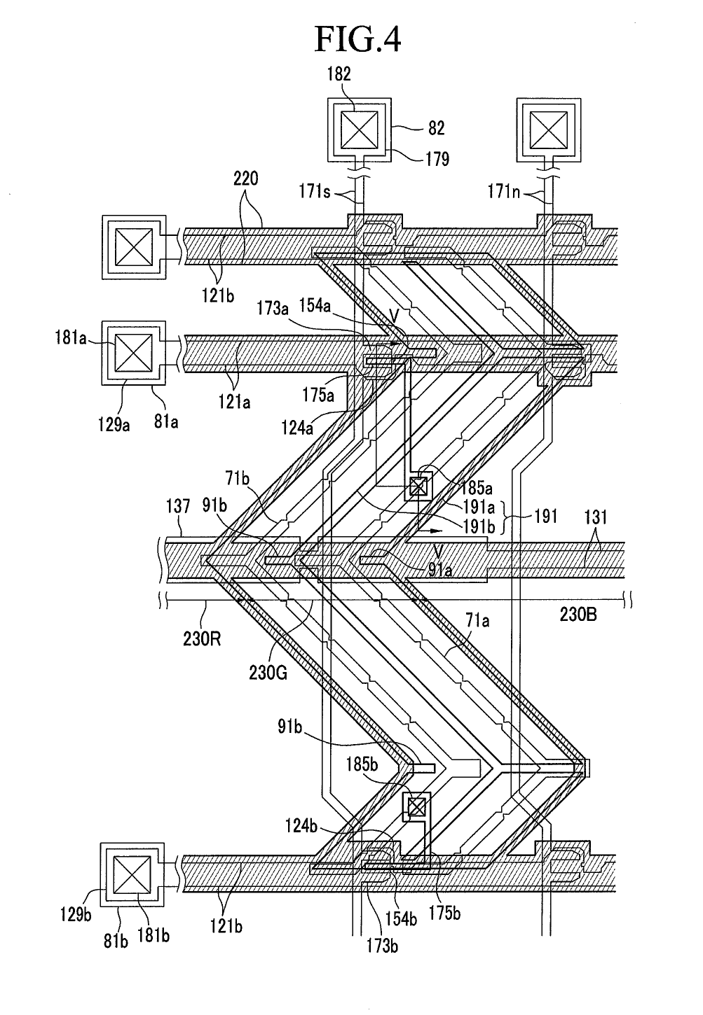

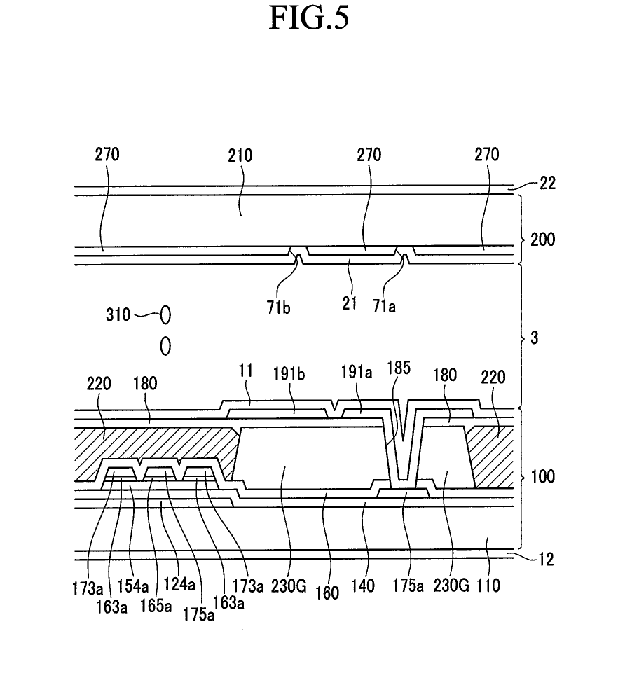

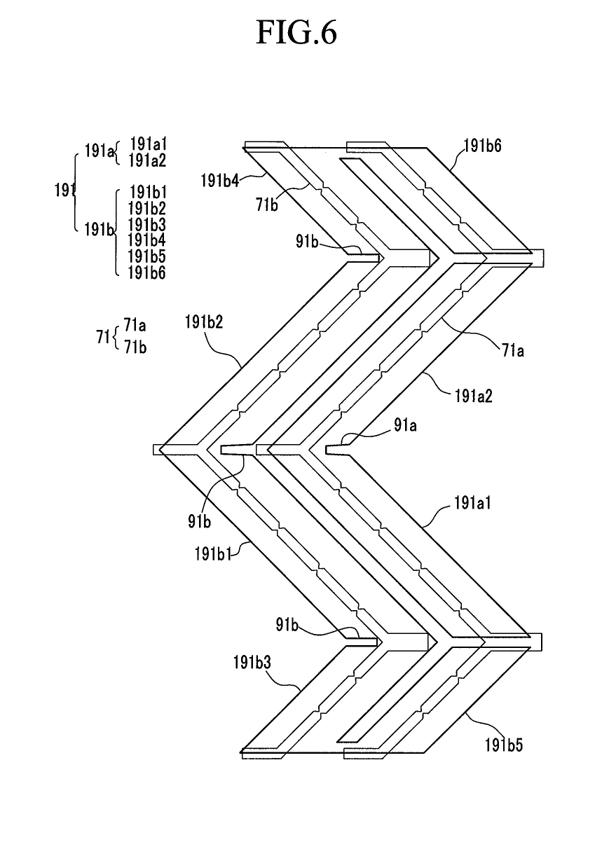

FIG. 3 is an equivalent circuit diagram for one pixel of a liquid crystal display according to another exemplary embodiment of the present invention. FIG. 4 is a layout view of a liquid crystal display of FIG. 3, FIG. 5 is a cross-sectional view of a liquid crystal display shown in FIG. 4 taken along the line V-V, and FIG. 6 is a layout view of a pixel electrode and a common electrode in a liquid crystal display shown in FIG. 4 and FIG. 5.

Referring to FIG. 3, each pixel PX includes a pair of subpixels PXa and PXb. Each of the subpixels PXa and PXb includes a switching element Qa or Qb connected to a corresponding gate line 121a or 121b and a data line 171s, a liquid crystal capacitor Clca or Clcb connected to the switching element Qa or Qb, and a storage capacitor Csta or Cstb connected to the switching element Qa or Qb and a storage electrode line 131.

Each of the switching elements Qa and Qb is a three terminal element having a control terminal, an input terminal, and an output terminal. The control terminal is connected to the gate lines 121a and 121b, and the input terminal is connected to the data line 171s. The output terminal is connected to the liquid crystal capacitor Clca or Clcb and the storage capacitor Csta or Cstb.

The storage capacitors Csta and Cstb have an accessorial role of the liquid crystal capacitors Clca and Clcb. The storage capacitors Csta and Cstb are formed by overlapping the storage electrode line 131 and a pixel electrode (not shown) with an insulator interposed therebetween. A predetermined voltage such as a common voltage Vcom is applied to the storage electrode line 131. However, the storage capacitors Csta and Cstb may be formed by overlapping a previous gate line on the sub-pixel electrodes PXa and PXb with an insulator interposed therebetween.

Referring to FIG. 4 and FIG. 5, the liquid crystal display according to the present exemplary embodiment includes a thin film transistor array panel 100, a common electrode panel 200 facing the thin film transistor array panel 100, and a liquid crystal layer 3 interposed between the thin film transistor array panel 100 and the common electrode panel 200.

Firstly, the thin film transistor array panel 100 will be described.

A plurality of pairs of first and second gate lines 121a and 121b and storage electrode lines 131 are formed on the insulating substrate 110.

The first and second gate lines 121a and 121b extend in a horizontal direction, and are located at an upper portion and a lower portion, respectively. The first gate line 121a includes a first gate electrode 124a protruding downwardly and an end portion 129a, and the second gate line 121b includes a second gate electrode 124b protruding upwardly and an end portion 129b.

The storage electrode line 131 extends in a horizontal direction and is interposed between the first gate line 121a and the second gate line 121b. Each storage electrode line 131 includes a plurality of storage electrodes 137 expanded downwardly and upwardly. However, shapes and arrangements of the storage electrodes 137 and the storage electrode lines 131 may vary.

A gate insulating layer 140 is formed on the first and second gate lines 121a and 121b and the storage electrode line 131, and a semiconductor stripe (not shown) is formed on the gate insulating layer 140. The semiconductor stripe mainly extends in a vertical direction, and includes first and second protrusions 154a and 154b extended towards the first and second gate electrodes 124a and 124b.

An ohmic contact stripe (not shown), a first ohmic contact island 165a, and a second ohmic contact island (not shown) are formed on the semiconductor stripe. The ohmic contact stripe includes a first protrusion 163a and a second protrusion (not shown). The first protrusion 163a and the first ohmic contact island 165a form a pair and are disposed on the protrusion 154a of the semiconductor stripe. The second protrusion and the second ohmic contact island form a pair and are disposed on the protrusion 154b of the semiconductor stripe.

A plurality of data lines 171s and 171n and a plurality of pairs of first and second drain electrodes 175a and 175b are formed on the ohmic contact stripe and the gate insulating layer 140.

The data lines 171s and 171n mainly extend in a vertical direction, thereby crossing the gate lines 121a and 121b and the storage electrode line 131. Overall, the data lines 171s and 171n are not straight lines, but are bent at least two times. Each of the data lines 171s and 171n includes a plurality of pairs of first and second source electrodes 173a and 173b extending toward the first and second gate electrodes 124a and 124b and an end 179.

The first drain electrode 175a faces the first source electrode 173a with the first gate electrode 124a as a center, and the second drain electrode 175b faces the second source electrode 173b with the second gate electrode 124b as a center. Ends of the first and second drain electrodes 175a and 175b are partially surrounded by bending parts of the first and second source electrodes 173a and 173b.

The semiconductor stripe has a plane shape that is substantially identical to that of the data lines 171s and 171n and the first and second drain electrodes 175a and 175b, except at a channel region between the first source electrode 173a and the first drain electrode 175a and a channel region between the second source electrode 173b and the second drain electrode 175b.

An ohmic contact stripe is interposed between the semiconductor stripe and the data lines 171s and 171n and has a shape that is substantially identical to that of the data lines 171s and 171n. The first ohmic contact islands 165a and the second ohmic contact islands (not shown) are interposed between the semiconductor stripe and the drain electrodes 175a and 175b, respectively. The first and second ohmic contact islands have a plane shape that is substantially identical to that of the first and second drain electrodes 175a and 175b.

A blocking layer 160 is formed on the data lines 171n and 171s and the first and second drain electrodes 175a and 175b. A color filter 230 and a light blocking member 220 are formed on the blocking layer 160.

The color filter 230 is bent several times along an edge of the pixel electrode 191. That is, the color filter 230 has a zigzag shape.

The light blocking member 220 includes an oblique line member formed along an edge of the color filter 230 in a zigzag shape, a straight line member formed along the first and second gate lines 121a and 121b and the storage electrode line 131, and a protrusion covering a thin film transistor.

The light blocking member 220 may be formed by mixing a plurality of color pigments like in the above-described exemplary embodiment.

A capping layer 180 is formed on the color filter 230.

Contact holes 185a and 185b are formed in the capping layer 180, the color filter 230, and the blocking layer 160 to expose the first and second drain electrodes 175a and 175b. Also, a contact hole 182 is formed in the capping layer 180 and the blocking layer 160 to expose the end portion 179 of the data lines 171s and 171n, and contact holes 181a and 181b are formed in the capping layer 180, the blocking layer 160, and the gate insulating layer 140 to expose an end portion 129 of the gate line 121.

A pixel electrode 191 and a plurality of contact assistants 81a, 81b, and 82 are formed on the capping layer 180.

Referring to FIG. 4 and FIG. 6, each pixel electrode 191 includes a pair of the first and second subpixel electrodes 191a and 191b that are isolated from each other. The first subpixel electrode 191a is adjacent to the second subpixel electrode 191b in a column direction, and the first and second subpixel electrodes 191a and 191b have cutouts 91a and 91b, respectively.

The first and second subpixel electrodes 191a and 191b have a structure that is formed by connecting a plurality of electrode plates formed in an approximate parallelogram shape made of a pair of oblique sides and a pair of horizontal sides. The first subpixel electrode 191a is formed of two electrode plates 191a1 and 191a2, and the second subpixel electrode 191b is made of six electrode plates 191b1, 191b2, 191b3, 191b4, 191b5, and 191b6. The first subpixel electrode 191a is bent once and has a cutout 91a at the bending part. Among the six electrode plates of the second subpixel electrode 191b, two electrode plates 191b5 and 191b6 disposed at the right side are disposed above and below the first subpixel electrode 191a, and four electrode plates 191b1 to 191b4 disposed at the left side are bent three times and include cutouts 91a and 91b at the bending part thereof.

The electrode plates 191a1, 191a2, 191b1, and 191b2 disposed at the middle have heights that are different from those of the electrode plates disposed above and below the electrode plates 191a1, 191a2, 191b1, and 191b2. For example, heights of the upper and lower electrode plates 191b3, 191b4, 191b5, and 191b6 are about half of the heights of the middle electrode plates 191a1, 191a2, 191b, and 191b2. Accordingly, an area ratio of the first subpixel electrode 191a and the second subpixel electrode 191b may be about 1:2. As described above, the area ratio of the first subpixel electrode 191a and the second subpixel electrode 191b can be controlled by controlling the heights of the upper and lower electrode plates 191b3, 191b4, 191b5, and 191b6.

In FIG. 4 and FIG. 6, the positional relationship and the bending direction of the first and second subpixel electrodes 191a and 191b may be changed. That is, the positional relationship and the bending direction can be deformed by symmetrically reversing the pixel electrode 191 from top to bottom and from right to left, or by rotating the pixel electrode 191.

The first subpixel electrode 191a is connected to the first drain electrode 175a through the contact hole 185a, and the second subpixel electrode 191b is connected to the second drain electrode 175b through the contact hole 185b.

As described above, the first subpixel electrode 191a and the second subpixel electrode 191b form one pixel electrode 191, and they receive different data voltages through the same data line 171s at different times because the first and second subpixel electrodes 191a and 191b are connected to the first and second drain electrodes 175a and 175b. Although unlikely, if the first subpixel electrode 191a is only connected to the thin film transistor and the second subpixel electrode 191b is only connected to a capacitor and the first subpixel electrode 191a, the first subpixel electrode 191a may only receive a data voltage and the second subpixel electrode 191b may receive a voltage that varies according to a voltage variation of the first subpixel electrode 191a. Here, the voltage of the first subpixel electrode 191a having a comparative small area is higher than the voltage of the second subpixel electrode 191b having a comparative large area.

Hereinafter, the common electrode panel 200 will be described.

A common electrode 270 is formed on the insulating substrate 210.

The common electrode 270 has cutouts 71a and 71b facing first and second subpixel electrodes 191a and 191b. The cutouts 71a and 71b include at least one of a plurality of oblique line members that extend substantially parallel with the hypotenuse of the first and second subpixel electrodes 191a and 191b, and a center member extending to the left or the right from the center of the first and second subpixel electrodes 191a and 191b. The oblique line members of the cutouts 71a and 71b have a plurality of notches.

Alignment layers 11 and 21 are formed at inner sides of the thin film transistor array panel 100 and the common electrode panel 200, and polarizers 12 and 22 are formed at outer sides of the thin film transistor array panel 100 and the common electrode panel 200.

A liquid crystal layer 3 is interposed between the thin film transistor array panel 100 and the common electrode panel 200. The liquid crystal layer 3 has negative dielectric anisotropy, and liquid crystal molecules 310 of the liquid crystal layer 3 are aligned to have a major axis to be perpendicular to the surfaces of the two display panels 100 and 200 without an electric field.

As described above, if the voltage of the first subpixel electrode 191a is different from the voltage of the second subpixel electrode 191b, a voltage acting on the first liquid crystal capacitor Clca formed between the first subpixel electrode 191a and the common electrode 270 is different from a voltage acting on the second liquid crystal capacitor Clcb formed between the second subpixel electrode 191b and the common electrode 270. Therefore, the liquid crystal molecules of the first subpixel are inclined at an angle that is different from the inclining angle of liquid crystal molecules of the second subpixel, so the luminance of the two subpixels are different. Therefore, it is possible to make an image viewed from a side maximally close to an image viewed from the front by matching the voltage of the first liquid crystal capacitor Clca with the voltage of the second liquid crystal capacitor Clcb. That is, it is possible to make a side gamma curve maximally close to a front gamma curve, thereby improving lateral visibility.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A resin composition for a light blocking member, comprising:
a polymerizable compound;
a binder; and
a pigment including R254, Y139, and B15:6.

2. The resin composition of claim 1, wherein the pigment comprises R254, Y139, and B15:6 at a ratio of about 1.5 to 2.5:about 0.5 to 1.5:about 2.5 to 3.5.

3. The resin composition of claim 2, wherein the pigment comprises R254, Y139, and B15:6 at a ratio of about 2:1:3.

4. The resin composition of claim 2, wherein the resin composition for the light blocking member has an optical density higher than 3 in a visible light region.

5. The resin composition of claim 1, wherein R254, Y139, and B15:6 are expressed as Chemical Formula 1, Chemical Formula 2, and Chemical Formula 3, respectively:

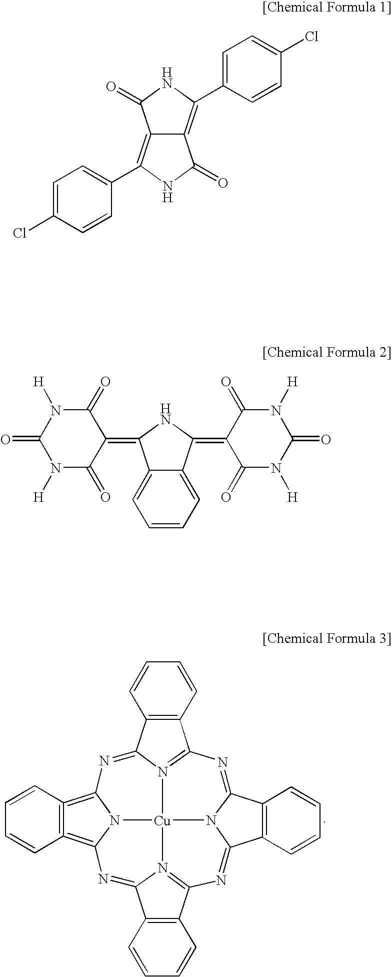

6. A display panel, comprising:
a substrate;
first and second signal lines formed on the substrate and crossing each other;
a thin film transistor connected to the first and second signal lines;
a plurality of color filters formed on the thin film transistor;
a light blocking member disposed between adjacent color filters and comprising a pigment including R254, Y139, and B15:6;
an insulating layer formed above or below the plurality of color filters and the light blocking member; and
a pixel electrode formed on the plurality of color filters.

7. The display panel of claim 6, wherein the pigment comprises R254, Y139, and B15:6 at a ratio of about 1.5 to 2.5:about 0.5 to 1.5:about 2.5 to 3.5.

8. The display panel of claim 7, wherein the pigment comprises R254, Y139, and B15:6 at a ratio of about 2:1:3.

9. The display panel of claim 7, wherein the light blocking member has an optical density higher than 3 in a visible light region.

10. The display panel of claim 6, wherein R254, Y139, and B15:6 are expressed as Chemical Formula 1, Chemical Formula 2, and Chemical Formula 3, respectively:

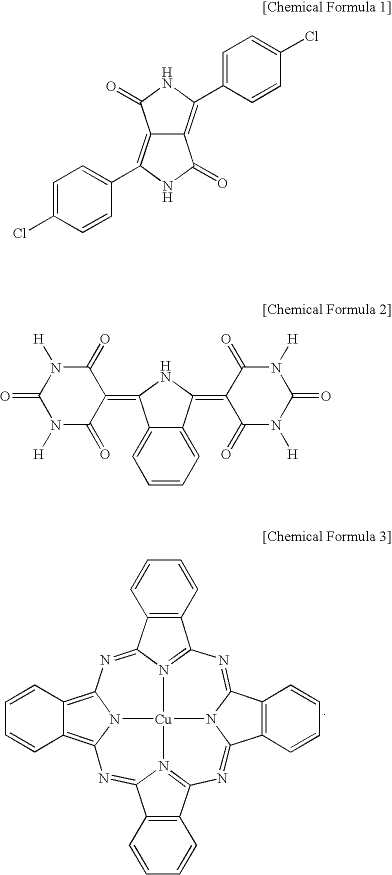

11. The display panel of claim 6, wherein the pixel electrode comprises first and second subpixel electrodes capable of receiving different voltages.

12. The display panel of claim 11, wherein each of the first and second subpixel electrodes comprises at least two parallelogram electrode plates each having a different inclining direction.

13. The display panel of claim 11, wherein at least one of the color filters has a zigzag shape.

14. The display panel of claim 13, wherein the light blocking member comprises:
a first part formed along an edge of the color filter in a zigzag shape; and
a second part formed along at least one of the first and second signal lines.

15. A display panel, comprising:
a substrate;
a gate line formed on the substrate;
a gate insulating layer formed on the gate line;
a data line formed on the gate insulating layer and crossing the gate line;
a plurality of color filters formed on the data line;
a light blocking member disposed between adjacent color filters;
an insulating layer formed above or below the color filters and the light blocking member; and
a pixel electrode formed on the color filters,
wherein the light blocking member is formed by mixing a red pigment, a yellow pigment, and a blue pigment at a ratio of about 1.5 to 2.5:about 0.5 to 1.5:about 2.5 to 3.5 and has an optical density higher than 3 in a visible light region.

16. The display panel of claim 15, wherein the red pigment, the yellow pigment, and the blue pigment are mixed at a ratio of about 2:1:3.

17. The display panel of claim 15, wherein the red pigment is R254 expressed as 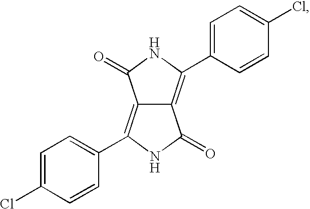
the yellow pigment is Y139 expressed as, 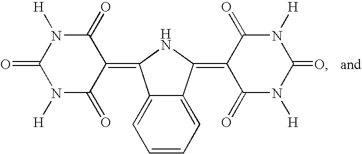
the blue pigment is B15:6 expressed as

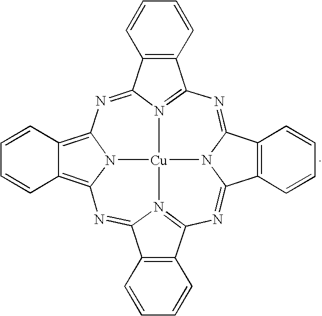

18. The display panel of claim 15, wherein the pixel electrode comprises first and second subpixel electrodes capable of receiving different voltages.

19. The display panel of claim 18, wherein the color filter has a zigzag shape, and
the light blocking member comprises a first part formed along an edge of the color filter in a form of a zigzag shape, and
a second part formed along the gate line.
